(19) United States
(12) Patent Application Publication
(10) Pub. No.: US 2021/0182760 A1
(43) Pub. Date: Jun. 17, 2021

(54) RULE CHANGE IMPACT ANALYZER

(71) Applicant: SAP SE, Walldorf (DE)

(72) Inventors: MICHAEL WULF, Bad Schoenborn (DE); Tina Marseille, Heidelberg (DE); Bernfried Niemann, Oestringen (DE); Miguel Rolando Heineken, Rauenberg (DE)

(21) Appl. No.: 16/713,747

(22) Filed: Dec. 13, 2019

(51) Int. Cl. G06Q 10/06; G06Q 10/10; G06F 3/0482; G06F 9/54

(52) U.S. Cl. CPC G06Q 10/06375; G06F 9/542; G06F 3/0482; G06Q 10/105

(57) ABSTRACT

Techniques for implementing a rule change impact analyzer are disclosed. In some example embodiments, a computer-implemented method comprises: determining that a change to a rule stored in a database has occurred; predicting a functional impact on one or more electronic resources due to the change to the rule; and causing an indication of the predicted functional impact on the one or more electronic resources to be displayed on a computing device of a user. The predicted functional impact may comprise an increase in runtime associated with performing one or more computer operations associated with complying with the rule. In some example embodiments, the method further comprises identifying a subset of people who are potentially affected by the change to the rule, with the functional impact on the electronic resource(s) being predicted based on the identified subset of people.

### TECHNICAL FIELD

The present application relates generally to the technical field of electrical computer systems, and, in various embodiments, to systems and methods of implementing a rule change impact analyzer configured to predict the impact of a rule change, such as the functional impact of the rule change on one or more electronic resources, as well as to provide user interface features for generating and responding to the predictions.

### BACKGROUND

There are frequently rule changes, such as legal changes, that need to be reflected and implemented into organization management systems, such as payroll systems. Complying with rule changes often involves additional consumption of resources, which results in technical problems for the computer system underlying the organizational management system. The impacts of rule changes are difficult to calculate, plan for, process, and oversee. Current solutions for managing rule changes are error prone, ineffective, and do not provide users with an efficient and easy way to operate a user interface for managing rule changes. Furthermore, current solutions do not provide users with a prediction of changes in the burden placed on electronic resources of the computer system resulting from rule changes. If a particular rule change requires the uploading of a file that will be significantly larger in size than prior to the rule change, this dramatic increase in file size applied to an extremely large number of employees may result in significantly larger database storage space being consumed and much longer runtimes in uploading or otherwise processing the files. By failing to provide users with a prediction of upcoming changes in the technical burden that will be placed on electronic resources due to rule changes, current solutions fail to enable users to mitigate the additional technical burden. The present disclosure addresses these and other technical problems that plague the computer functionality of online services.

### BRIEF DESCRIPTION OF THE DRAWINGS

Some example embodiments of the present disclosure are illustrated by way of example and not limitation in the figures of the accompanying drawings, in which like reference numbers indicate similar elements.

FIG. 1 is a network diagram illustrating a client-server system, in accordance with some example embodiments.

FIG. 2 is a block diagram illustrating enterprise applications and services in an enterprise application platform, in accordance with some example embodiments.

FIG. 3 is a block diagram illustrating an impact analyzer system, in accordance with some example embodiments.

FIG. 4 illustrates a user interface in which a notification of a change to a rule is displayed, in accordance with some example embodiments.

FIG. 5 illustrates a user interface in which an indication of a predicted impact of a change to a rule is displayed, in accordance with some example embodiments.

FIG. 6 illustrates a message creation element, in accordance with some example embodiments.

FIG. 7 illustrates a user interface in which an indication of a predicted financial impact of a change to a rule is displayed, in accordance with some example embodiments.

FIG. 8 illustrates a user interface in which an indication of a predicted functional impact of a change to a rule is displayed, in accordance with some example embodiments.

FIG. 9 is a flowchart illustrating a method of implementing a rule change impact analyzer, in accordance with some example embodiments.

FIG. 10 is a flowchart illustrating a method of implementing a rule change impact analyzer, in accordance with some example embodiments.

FIG. 11 is a flowchart illustrating a method of implementing a rule change impact analyzer, in accordance with some example embodiments.

FIG. 12 is a block diagram of an example computer system on which methodologies described herein can be executed, in accordance with some example embodiments.

### DETAILED DESCRIPTION

Example methods and systems for implementing a rule change impact analyzer configured to predict the impact of a rule change, such as the functional impact of the rule change on one or more electronic resources, as well as to provide user interface features for generating and responding to the predictions are disclosed. In the following description, for purposes of explanation, numerous specific details are set forth in order to provide a thorough understanding of example embodiments. It will be evident, however, to one skilled in the art that the present embodiments can be practiced without these specific details.

The implementation of the features disclosed herein involves a non-generic, unconventional, and non-routine operation or combination of operations. By applying one or more of the solutions disclosed herein, some technical effects of the system and method of the present disclosure are to provide a computer system that is configured to predict the impact of a rule change, such as the functional impact of the rule change on one or more electronic resources, as well as to provide user interface features for generating and responding to the predictions. As a result of the features disclosed herein, the functioning of the computer system is improved. Other technical effects will be apparent from this disclosure as well.

The methods or embodiments disclosed herein may be implemented as a computer system having one or more modules (e.g., hardware modules or software modules). Such modules may be executed by one or more hardware processors of the computer system. In some example embodiments, a non-transitory machine-readable storage device can store a set of instructions that, when executed by at least one processor, causes the at least one processor to perform the operations and method steps discussed within the present disclosure.

The details of one or more variations of the subject matter described herein are set forth in the accompanying drawings and the description below. Other features and benefits of the subject matter described herein will be apparent from the description and drawings, and from the claims.

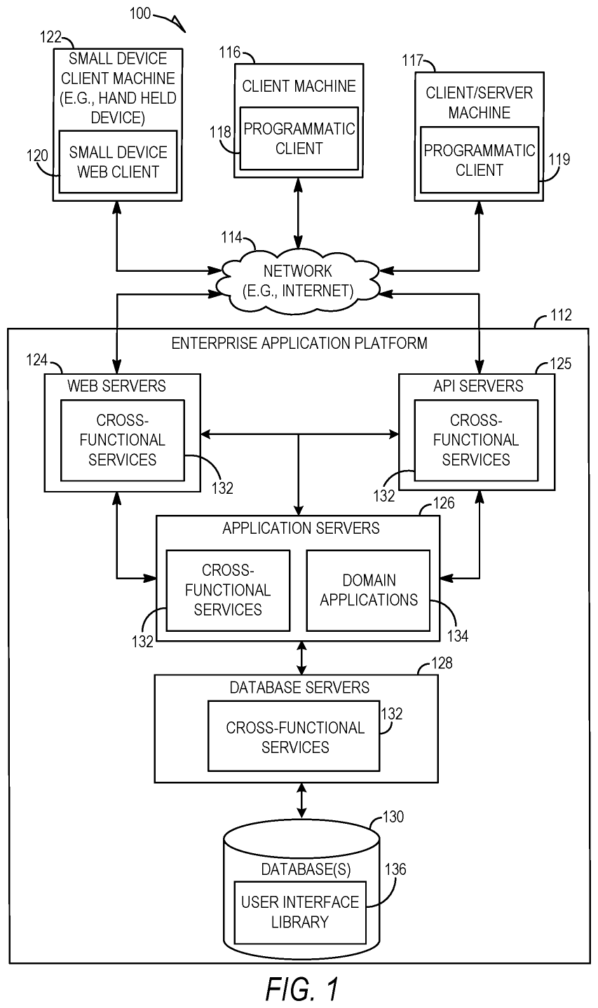

FIG. 1 is a network diagram illustrating a client-server system 100, in accordance with some example embodiments. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser), a small device client machine 122 with a small device web client 120 (e.g., a browser without a script engine), and a client/server machine 117 with a programmatic client 119.

Turning specifically to the example enterprise application platform 112, web servers 124 and Application Program Interface (API) servers 125 can be coupled to, and provide web and programmatic interfaces to, application servers 126. The application servers 126 can be, in turn, coupled to one or more database servers 128 that facilitate access to one or more databases 130. The web servers 124, API servers 125, application servers 126, and database servers 128 can host cross-functional services 132. The cross-functional services 132 can include relational database modules to provide support services for access to the database(s) 130, which includes a user interface library 136. The application servers 126 can further host domain applications 134.

The cross-functional services 132 provide services to users and processes that utilize the enterprise application platform 112. For instance, the cross-functional services 132 can provide portal services (e.g., web services), database services, and connectivity to the domain applications 134 for users that operate the client machine 116, the client/server machine 117, and the small device client machine 122. In addition, the cross-functional services 132 can provide an environment for delivering enhancements to existing applications and for integrating third-party and legacy applications with existing cross-functional services 132 and domain applications 134. Further, while the system 100 shown in FIG. 1 employs a client-server architecture, the embodiments of the present disclosure are, of course, not limited to such an architecture, and could equally well find application in a distributed, or peer-to-peer, architecture system.

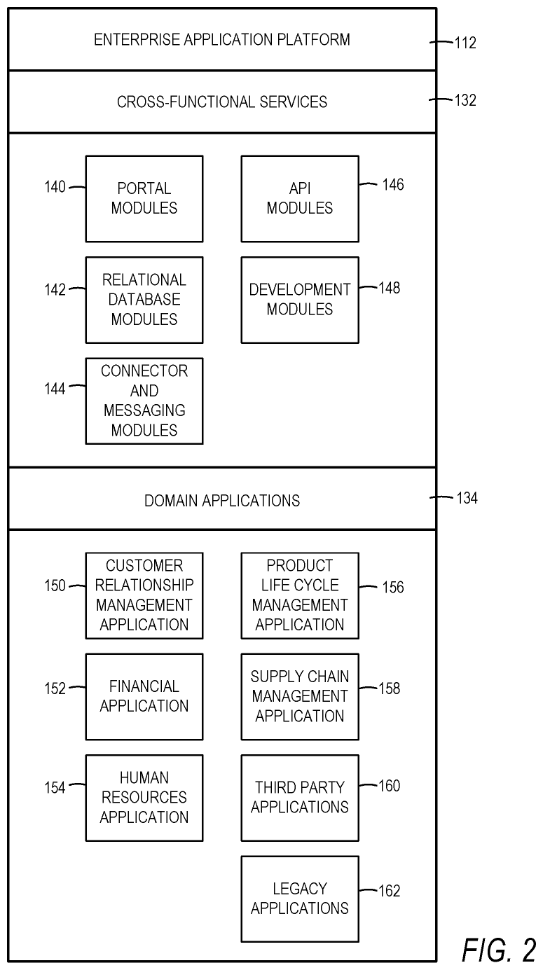

The enterprise application platform 112 can improve (e.g., increase) accessibility of data across different environments of a computer system architecture. For example, the enterprise application platform 112 can effectively and efficiently enable a user to use real data created from use by one or more end users of a deployed instance of a software solution in a production environment when testing an instance of the software solution in the development environment. The enterprise application platform 112 is described in greater detail below in conjunction with FIGS. 2-11.

FIG. 2 is a block diagram illustrating enterprise applications and services in an enterprise application platform 112, in accordance with an example embodiment. The enterprise application platform 112 can include cross-functional services 132 and domain applications 134. The cross-functional services 132 can include portal modules 140, database modules 142 (e.g., relational database modules), connector and messaging modules 144, API modules 146, and development modules 148.

The portal modules 140 can enable a single point of access to other cross-functional services 132 and domain applications 134 for the client machine 116, the small device client machine 122, and the client/server machine 117. The portal modules 140 can be utilized to process, author and maintain web pages that present content (e.g., user interface elements and navigational controls) to the user. In addition, the portal modules 140 can enable user roles, a construct that associates a role with a specialized environment that is utilized by a user to execute tasks, utilize services, and exchange information with other users within a defined scope. For example, the role can determine the content that is available to the user and the activities that the user can perform. The portal modules 140 include a generation module, a communication module, a receiving module and a regenerating module. In addition, the portal modules 140 can comply with web services standards and/or utilize a variety of Internet technologies including JAVA®, J2EE, SAP's Advanced Business Application Programming Language (ABAP®) and Web Dynpro, XML, JCA, JAAS, X.509, LDAP, WSDL, WSRR, SOAP, UDDI and MICROSOFT® .NET®.

The database modules 142 can provide support services for access to the database(s) 130, which includes a user interface library 136. The database modules 142 can provide support for object relational mapping, database independence, and distributed computing. The database modules 142 can be utilized to add, delete, update, and manage database elements. In addition, the database modules 142 can comply with database standards and/or utilize a variety of database technologies including SQL, SQLDBC, Oracle, MySQL, Unicode, JDBC, or the like.

The connector and messaging modules 144 can enable communication across different types of messaging systems that are utilized by the cross-functional services 132 and the domain applications 134 by providing a common messaging application processing interface. The connector and messaging modules 144 can enable asynchronous communication on the enterprise application platform 112.

The API modules 146 can enable the development of service-based applications by exposing an interface to existing and new applications as services. Repositories can be included in the platform as a central place to find available services when building applications.

The development modules 148 can provide a development environment for the addition, integration, updating, and extension of software components on the enterprise application platform 112 without impacting existing cross-functional services 132 and domain applications 134.

Turning to the domain applications 134, a customer relationship management application 150 can enable access to and can facilitate collecting and storing of relevant personalized information from multiple data sources and business processes. Enterprise personnel that are tasked with developing a buyer into a long-term customer can utilize the customer relationship management applications 150 to provide assistance to the buyer throughout a customer engagement cycle.

Enterprise personnel can utilize financial applications 152 and business processes to track and control financial transactions within the enterprise application platform 112. The financial applications 152 can facilitate the execution of operational, analytical, and collaborative tasks that are associated with financial management. Specifically, the financial applications 152 can enable the performance of tasks related to financial accountability, planning, forecasting, and managing the cost of finance.

Human resource applications 154 can be utilized by enterprise personnel and business processes to manage, deploy, and track enterprise personnel. Specifically, the human resource applications 154 can enable the analysis of human resource issues and facilitate human resource decisions based on real-time information.

Product life cycle management applications 156 can enable the management of a product throughout the life cycle of the product. For example, the product life cycle management applications 156 can enable collaborative engineering, custom product development, project management, asset management, and quality management among business partners.

Supply chain management applications 158 can enable monitoring of performances that are observed in supply chains. The supply chain management applications 158 can facilitate adherence to production plans and on-time delivery of products and services.

Third-party applications 160, as well as legacy applications 162, can be integrated with domain applications 134 and utilize cross-functional services 132 on the enterprise application platform 112.

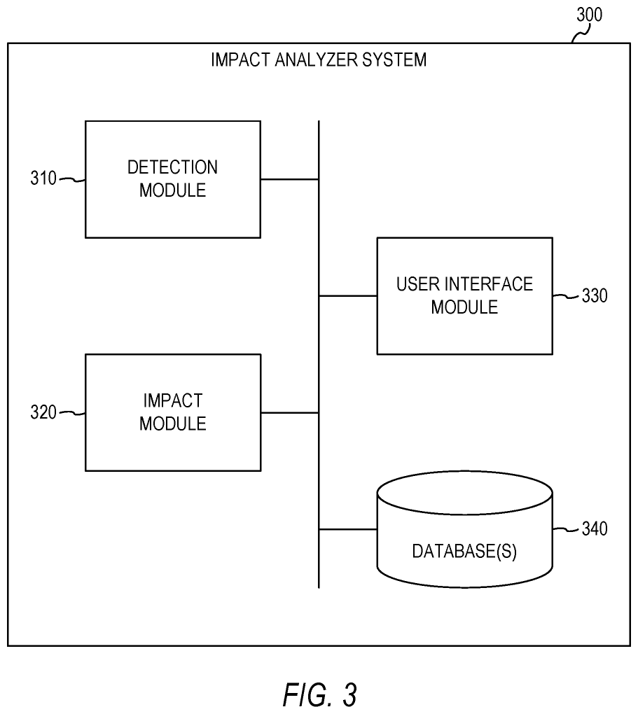

FIG. 3 is a block diagram illustrating an impact analyzer system 300, in accordance with some example embodiments. In some embodiments, the impact analyzer system 300 comprises any combination of one or more of a detection module 310, an impact module 320, a user interface module 330, and one or more database(s) 340. The modules 310, 320, and 330 and the database(s) 340 can reside on a computer system, or other machine, having a memory and at least one processor (not shown). In some embodiments, the modules 310, 320, and 330 are incorporated into the application server(s) 126 in FIG. 1 and the database(s) 340 is incorporated into the database(s) 130 in FIG. 1. However, it is contemplated that other configurations of the modules 310, 320, and 330 and the database(s) 340 are also within the scope of the present disclosure.

In some example embodiments, one or more of the modules 310, 320, and 330 are configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the modules 310, 320, and 330 are configured to receive user input. For example, one or more of the modules 310, 320, and 330 can present one or more graphical user interface (GUI) elements (e.g., drop-down menu, selectable buttons, text field) with which a user can submit input. In some example embodiments, one or more of the modules 310, 320, and 330 are configured to perform various communication functions to facilitate the functionality described herein, such as by communicating with a computing device (e.g., the small device client machine 122, the client machine 116, or the client/server machine 117) via the network 114 using a wired or wireless connection.

In some example embodiments, the impact analyzer system 300 is configured to function as a rule change impact analyzer that predicts the impact of a rule change and that provides user interface features for generating and responding to the predictions. The impact may comprise a financial impact on an entity or organization (e.g., a change in financial cost or contribution as a result of a rule change) or a functional impact on one or more electronic resources (e.g., a change in memory space consumed or a change in operational runtime for a computer system as a result of a rule change). Other types of impacts are also within the scope of the present disclosure and may be predicted by the impact analyzer system 300 as well. In some example embodiments, the impact analyzer system 300 is configured to identify which people, or other entities, within an organization (e.g., which employees or other members of an organization) will be affected by a change in a rule, as well determine in what way each of those people will be affected and how the aggregation of those people, and thereby the organization, will be affected by the change in the rule.

One example of a component of an organization that is affected by a rule change is a payroll system of an organization. Frequently, there are legal changes in every country in the world that need to be reflected and implemented into payroll systems, including, but not limited to, changes in bank account numbering systems and formats (e.g., changes in the International Bank Account Numbering (IBAN) system, changes in the Business Identifier Codes (BIC) system, changes in the Single Euro Payments Area (SEPA) system), changes in employer contribution for social security or other benefit programs, and retroactive change or clarification of a regulation.

Typically, there are hundreds of notes for legal changes delivered per year per country. For example, in Germany, a change in the social insurance takes about 15-20 notes, from pre-announcement, delivery, clarifications, and corrections. It is estimated that most of these legal changes need an extra amount of work by users to activate or implement the legal change in their payroll systems and in order to estimate the follow-up tasks and the effect on their payroll. Today, a company may have at least one payroll expert per country responsible for legal changes. The more employees per country, the more payroll experts there are likely to be. Furthermore, for every new country, there is at least an additional payroll expert. The payroll experts monitor a list of legal changes on publications of relevant authorities in order to identify the relevant legal changes. From the legal changes, they try to understand if and when they need to take care of the legal change. They also try to understand when they need to plan to implement a legal change. The payroll experts need to plan actions accordingly, such as collection from employees of data relevant to the legal change, as well as implementing and testing the legal change.

It is therefore crucial to understand the effect of a legal change on the organization, such as the effect on human resource processes, budget, and employees, as well as the strain that the legal change may have on electronic resources of the organization (e.g., computer memory consumption, computer processing workload). An agent of the organization may collect new data from employees, such as collecting IBAN and BIC from all employees, oversee progress of the data collection, and inform the unresponsive employees to adjust their data. Additionally, changes in social security contribution may affect a budget that is allocated to the human resources department of an organization, such as making employees more expensive. Agents of an organization may also set retroactive accounting in payroll for employees who are affected by a clarified regulation. The effects of rule changes are difficult to oversee, calculate, plan, and process. Inaccurate and inefficient management of rule changes leads to errors and inefficiency in the operation of an organization's resources, including electronic resources (e.g., computer systems).

Furthermore, errors in the handling of rule changes usually lead to questions from employees, which raise human resource tickets that need to be processed, which results in an increased burden on the electronic resources of an organization associated with attempts to resolve the tickets (e.g., additional consumption of network bandwidth as a result of additional electronic messages associated with the tickets, additional computer storage of the electronic messages.

The impact analyzer system 300 enables a user to study the impact of each rule change, providing guidance on how to handle the rule change, analysis of the impact of the rule change, and the status of the impact analysis, as well as other related information. In some example embodiments, the detection module 310 is configured to determine that a change to a rule has occurred. In some example embodiments, the detection module 310 detects that a rule that is stored in a database, such as in the database(s) 340, has been changed. The detection module 310 may determine that the rule change has occurred by periodically accessing the database(s) 340 to make the determination (e.g., checking to see if a rule has been flagged in the database as having been recently changed) or may receive an indication of the rule change from another computer component (e.g., rule change notifications may be pushed or pulled to the detection module 310 from a system that notifies organizations of rule changes). The detection module 310 may also determine that the rule change has occurred via a user manually entering details of the rule change directly into the impact analyzer system 300, where the entered details of the rule change may be stored in the database(s) 340. Other ways of determining that a change to a rule has occurred are also within the scope of the present disclosure.

In some example embodiments, the impact module 320 is configured to identify a subset of people who are potentially affected by the change to the rule. The subset of people is identified from a group of people larger in quantity than the subset of people. For example, if a change is made to a rule that only affects salaried employees, as opposed to employees that are compensated based on hourly wages, then the impact module 320 may identify all of the salaried employees in the organization as being potentially affected by the rule change. In some example embodiments, the impact module 320 accesses corresponding records of people in an organization (e.g., employee records) stored in the database(s) 340, and analyzes the accessed records to identify which people in the organization satisfy one or more criteria for determining who is potentially affected by the rule change. In the example above, the accessed records may be used by the impact module 320 to determine which employees are salaried employees.

In some example embodiments, the impact module 320 is configured to make an initial determination as to which people are potentially affected by the change to the rule, and then subsequently refines that determination to make a determination as to which people have been verified to be affected by the change to the rule. For example, the impact analyzer system 300 may be configured to query people for information, and then receive the information from the people, as will be discussed below with respect to the user interface module 330. The impact module 320 may use the information received from the people, such as information received via reply electronic messages, to determine which of the people who have been identified as being potentially affected by the rule change have been verified as being affected by the rule change. For example, in addition to only affecting salaried employees, a rule change may also only affect employees having 3 or more children. Therefore, the impact module 320 may first identify all of the salaried employees as being potentially affected by the rule change, then transmit electronic messages to those identified salaried employees prompting them to reply with the number of children they each have, and finally use their replies to verify which of the salaried employees have 3 or more children and will, therefore, be affected by the rule change. Other use cases are also within the scope of the present disclosure.

In some example embodiments, the user interface module 330 is configured to cause a notification to be displayed on a computing device of a user. The notification may indicate that the change to the rule potentially affects the subset of people. In some example embodiments, the notification comprises any combination of one or more of an identification of the rule change, a detailed explanation of the rule change, indications of how many people are affected by the rule change, indications of different groupings to which the affected people belong (e.g., the specific department within the organization to which each person belongs), and a corresponding identity of each person affected by the rule change.

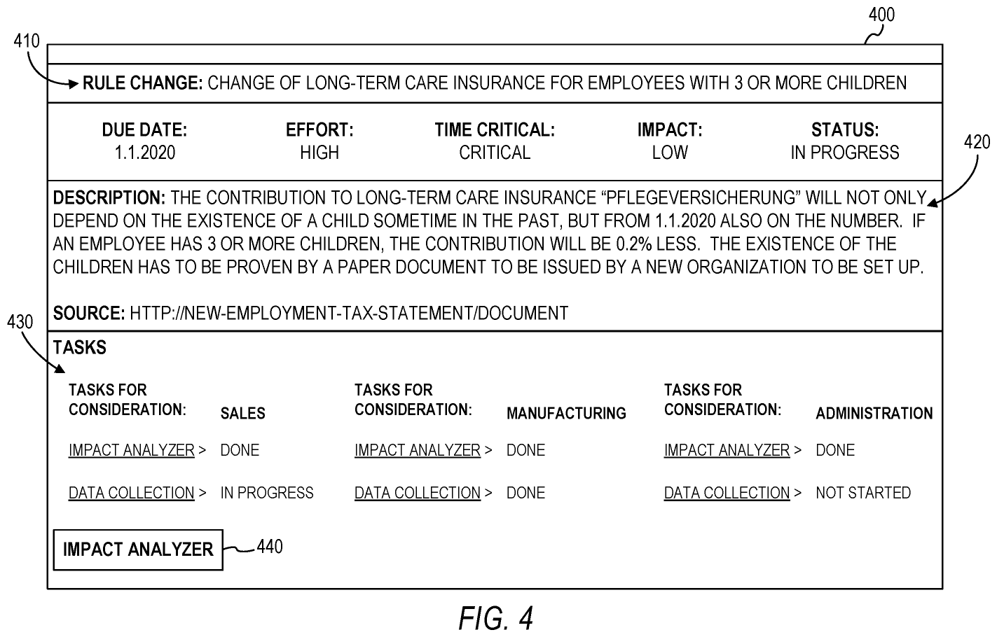

FIG. 4 illustrates a user interface 400 in which a notification of a change to a rule is displayed, in accordance with some example embodiments. In FIG. 4, the notification comprises an identification 410 of the rule change and a detailed explanation 420 of the rule change. In some example embodiments, the user interface module 330 is configured to display an indication 430 of one or more tasks to be performed as a result of the rule change. The indication 430 may be displayed as part of the notification displayed in FIG. 4 or as part of a separate user interface notification. In some example embodiments, the indication 430 of the tasks comprises details as to the status of each different task, such as whether the task has been completed (e.g., “DONE”), is being performed but not yet completed (e.g., “IN PROGRESS”), or has not yet been started (e.g., “NOT STARTED”). The indication 430 may display the tasks by different groupings of people, such as by different departments within an organization (e.g., sales department, manufacturing department, administrative department).

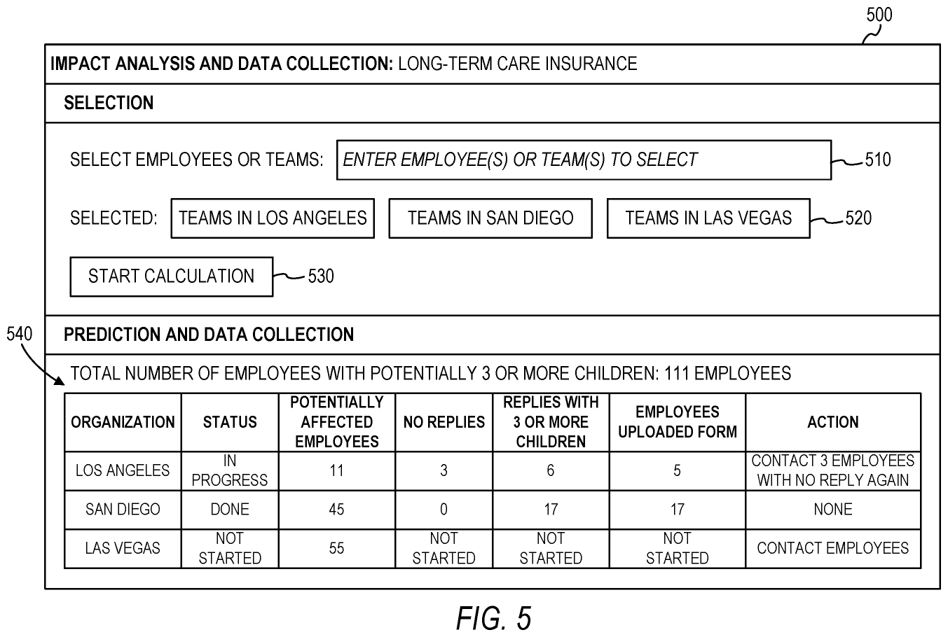

In some example embodiments, the notification comprises a selectable user interface element 440 configured to enable the user to view an impact analysis for the rule change. FIG. 5 illustrates a user interface 500 in which an indication of a predicted impact of a change to a rule is displayed, in accordance with some example embodiments. In some example embodiments, the user interface module 330 causes the display of the user interface 500 in FIG. 5 in response to a user selection of the user interface element 440 in FIG. 4. The user interface 500 is configured to enable the user to submit, via user interface elements, user input that may be used as parameters in predictions that are calculated by the impact module 320. For example, in FIG. 5, the user interface 500 comprises a field 510 that is configured to receive user input identifying people (e.g., a specific employee) or groups of people (e.g., a specific department or team within an organization), as well as indications 520 of the people or groups of people that have already been selected by the user for use in the prediction. The user interface 500 also comprises a selectable user interface element 530 configured to trigger an analysis of the rule change using the user input as parameters for the analysis.

In some example embodiments, the user interface module 330 is configured to display a summary 540 of tasks to be performed as a result of the rule change. As seen in FIG. 5, the summary 540 may comprise indications of, by person or grouping of people (e.g., department or team), a current status of a task to be performed, a corresponding number of people affected by the rule change and for whom the task is to be performed, a corresponding number of replies or other signals of completion of the task, a corresponding number of the replies that indicate a satisfaction of one or more criteria of the rule change (e.g., the number of replies that indicated that the corresponding employee has 3 or more children), a corresponding number of people that have performed another task associated with the rule change (e.g., the number of employees that have uploaded a form that is required for compliance with the rule change), and a recommended action for the user to perform with respect to the tasks (e.g., a recommendation to contact an unresponsive employee or group of employees).

In some example embodiments, the recommended action comprises a recommendation to contact one or more of the identified subset of people, such as to inform the identified subset of people of the rule change or to prompt the identified subset of people to provide data to be used in a subsequent analysis of the impact of the rule change. In FIG. 5, the user interface module 330 displays a recommendation to contact the 3 remaining employees (of the potentially affected 11 employees) that have not yet replied to the electronic message requesting information (e.g., “CONTACT 3 EMPLOYEES WITH NO REPLY AGAIN”) and a recommendation to contact all of the potentially affected 55 employees in the Las Vegas Team to obtain information since no electronic message requesting the information has been sent yet to any of those employees. In some example embodiments, the user interface module 330 displays a selectable user interface element configured to trigger the transmission of an electronic message to the recommended employees or to trigger a message creation process. For example, in FIG. 5, the recommendation “CONTACT EMPLOYEES” may comprise a corresponding selectable user interface element configured to trigger the generation and transmission of an electronic message to all of the employees in the identified subset or to trigger a message creation process via which the user can create the electronic message to be sent to all of the employees in the identified subset.

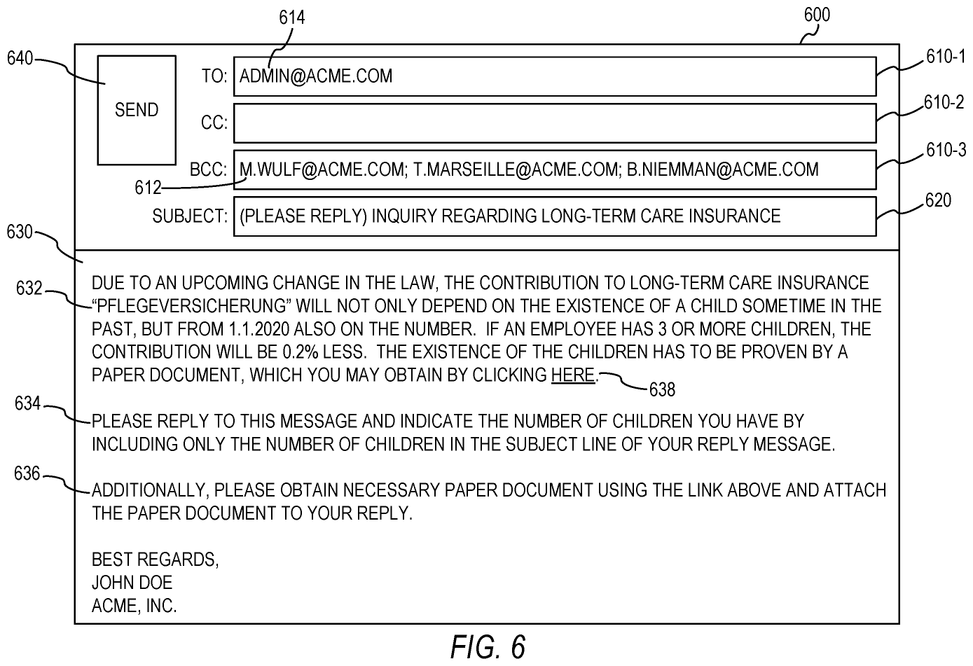

FIG. 6 illustrates a message creation element 600, in accordance with some example embodiments. In some example embodiment, the message creation element 600 is displayed in response to a selection of the user interface element corresponding to the recommended action discussed above. The message creation element 600 may comprise one or more address fields 610 configured to enable the user to enter, select, or otherwise specify one or more electronic destinations 612 (e.g., e-mail address, phone number) for the electronic message. For example, the message creation element 600 may comprise a main address field 610-1, a carbon copy address field 610-2, and a blind carbon copy address field 610-3, which the user may use to specify recipients of the electronic message. The message creation element 600 may also comprise a subject field 620 configured to enable the user to enter, select, or otherwise specify a subject for the electronic message, and a body field 630 configured to enable the user to enter, select, or otherwise provide text to be included in the body of the electronic message.

In some example embodiments, the user interface module 330 is configured to auto-populate one or more address fields 610 with an electronic destination 612 of at least one person in the identified subset of people. The address field 610 may be auto-populated with the entire identified subset of people. In some example embodiments, in order to maintain data privacy, particularly with any private information that is provided by a recipient in a reply message, the user interface module 330 is configured to auto-populate the address fields 610 with corresponding electronic destinations 612 of the identified subset of people in a way that prevents a reply message (e.g., triggered by a selection of a “Reply” or “Reply All” button) from one of the identified subset of people from being sent to any of the other people in the identified subset of people. For example, the user interface module 330 may auto-populate the main address field 610-1 with an electronic destination 614 of an administrator or other trusted agent of the organization (e.g., “ADMIN@ACME.COM” in FIG. 6) and auto-populate the blind carbon copy address field 610-3 with the corresponding electronic destinations 612 of all of the people in the identified subset of people (e.g., “M.WULF@ACME.COM,” “T.MARSEILLE@ACME.COM,” and “B.NIEMMAN@ACME.COM” in FIG. 6) so that each one of the identified subset of people may reply to the electronic message without any of the other people in the identified subset of people receiving their reply message, which still enabling the administrator or other trusted agent of the organization to create and send an electronic message to each one of the people in the identified subset of people using only a single message creation element 600 (e.g., without having to create and send a separate electronic message to each person in the identified subset of people separately).

In some example embodiments, the body field 630 of the message creation element is auto-populated with one or more of an explanation 632 of the rule change, a prompting 634 to reply to the electronic message, and additional instructions 636 for another task to perform other than replying to the electronic message. In some example embodiments, the body field 630 is auto-populated with a selectable link 638 configured to navigate the recipient of the electronic message to a page or other user interface where the recipient may perform at least a portion of the other task (e.g., a link configured to, in response to its selection, navigate the recipient to a website where the recipient may obtain one or more documents that need to be uploaded for compliance with the rule change). The message creation element 600 may also comprise a selectable user interface element 640 (e.g., a selectable “SEND” button) configured to trigger transmission of the electronic message to the recipients indicated in the address field 610 in response to its selection.

In some example embodiments, the user interface module 330 is configured to automatically generate, auto-populate, and transmit a corresponding electronic message to each person in the identified subset of people via a corresponding electronic destination of the person in response to selection of a selectable user interface element corresponding to a recommendation to contact the identified subset of people. For example, in FIG. 5, a user selection of the recommendation “CONTACT EMPLOYEES” may trigger the generation, auto-population, and transmission of an electronic message to all of the people in the identified subset of people, thereby reducing the number of steps that need to be performed by the user in sending the electronic message to each person in the identified subset of people, since the user would only need to select a single selectable user interface element provided in the notification in order to trigger a mass transmission to every person in the identified subset of people.

In some example embodiments, the impact module 320 is configured to predict an impact of the change to the rule on an entity with which the identified subset of people are associated based on user input that indicates and is used as at least one parameter for the prediction of the impact. The impact module 320 may predict the impact of the change to the rule by performing one or more calculations for one or more metrics (e.g., financial cost) related to the rule. In some example embodiments, the models, algorithms, or formulas used for the calculations of the metrics are stored in the database(s) 340, where they are accessed by the impact module 320 to calculate the metrics for the predicted impact. The impact module 320 may also access other data stored in the database(s) 340 for the use in the calculations, such as employee records and the information received via the replies of the identified subset of people, such as the replies that are tracked.

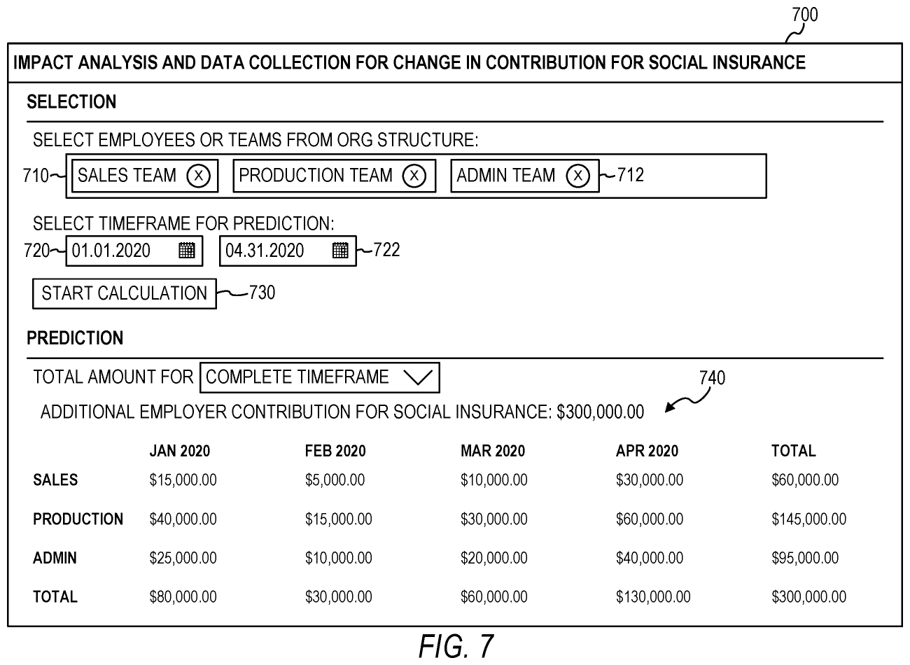

In some example embodiments, the user interface module 330 is configured to cause an indication of the predicted impact of the change to the rule to be displayed on the computing device of the user. FIG. 7 illustrates a user interface 700 in which one or more indications 740 of a predicted financial impact of a change to a rule is displayed, in accordance with some example embodiments. The user interface 700 comprises user interface elements configured to enable the user to provide the user input to be used as parameters in the prediction of the impact. For example, in FIG. 7, the user interface 700 comprises a user interface element 710 configured to enable the user to enter, select, or otherwise provide an indication 712 of a person or group of people for which the prediction is to be made, as well user interface elements 720 and 722 configured to enable the user to enter, select, or otherwise provide a timeframe for which the prediction is to be made. The user interface 700 may also comprise a selectable user interface element 730 configured to trigger a generation of the prediction and a display of the indication(s) 740 of the prediction in response to its selection. In some example embodiments, the indication(s) 740 of the predicted impact comprises a predicted financial impact of the rule change. The indication(s) 740 may comprise a bottom-line summary of the predicted financial impact (e.g., “ADDITIONAL EMPLOYER CONTRIBUTION FOR SOCIAL INSURANCE: $300,000.00” in FIG. 7) or a detailed break-down of the predicted financial impact (e.g., the detailed table in FIG. 7 showing the monthly additional employer contribution for social insurance by department). Other types of indications of the predicted impact are also within the scope of the present disclosure.

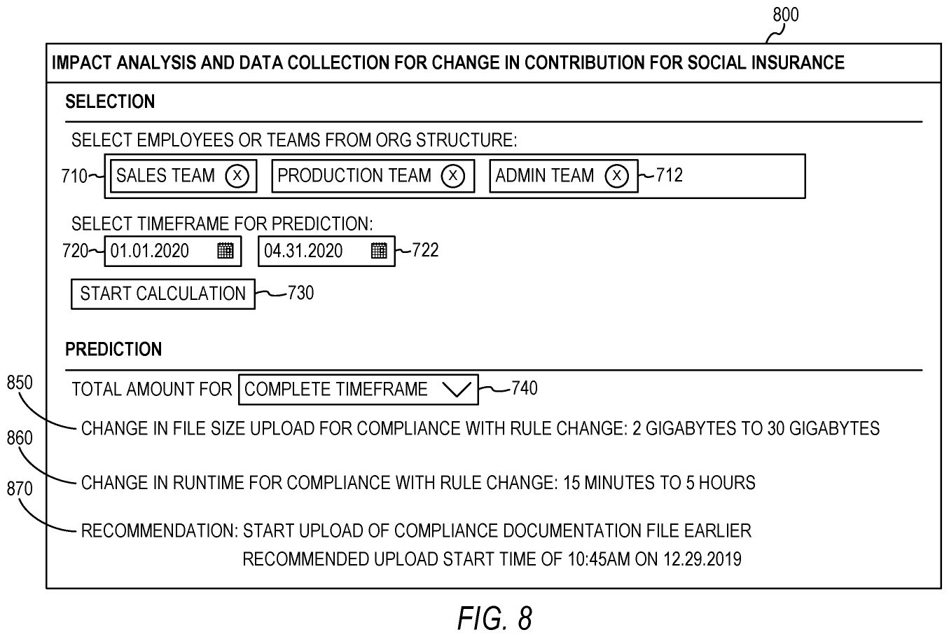

In some example embodiments, the impact module 320 is configured to predict a functional impact on one or more electronic resources of an organization due to the change to the rule, and the user interface module 330 is configured to cause an indication of the functional impact to be displayed on the computing device of the user. FIG. 8 illustrates a user interface 800 in which an indication of a predicted functional impact of a change to a rule is displayed, in accordance with some example embodiments. As seen in FIG. 8, the indication of the predicted functional impact may comprise one or more of an indication 850 of a change in an amount of file size or memory requirements associated with complying with the rule and an indication 860 of an increase in runtime associated with performing one or more computer operations associated with complying with the rule. However, other types of functional impacts may be predicted as well. In some example embodiments, the impact module 320 is configured to generate and the user interface module 330 is configured to display a recommendation 870 of one or more actions the user should take to mitigate the impact of the change to the rule. The recommendation 870 may be generated based on calculations using any combination of one or more of the details of the rule change, the identification of which employees will be affected by the rule change, employee records, and technical specifications of one or more electronic resources (e.g., available memory, available bandwidth, type of hardware processor).

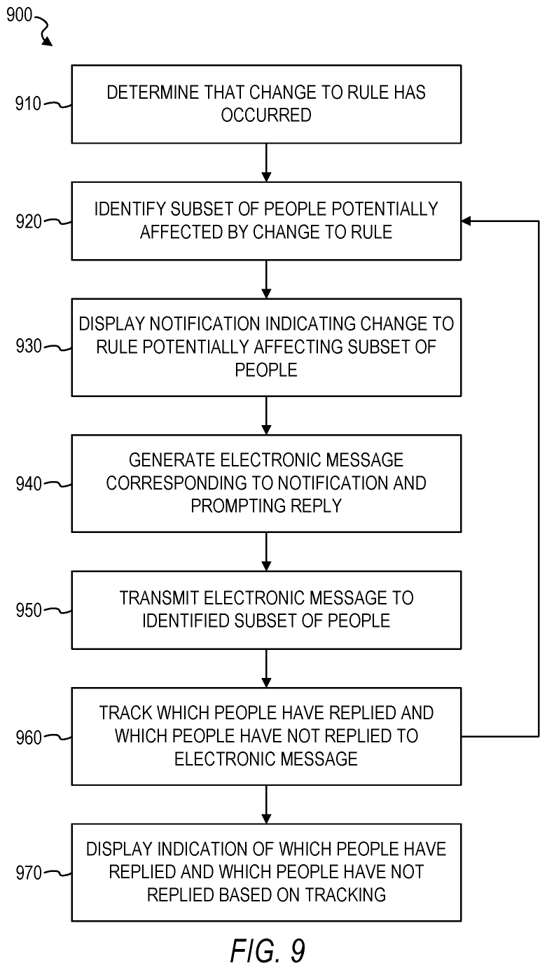

FIG. 9 is a flowchart illustrating a method 900 of implementing a rule change impact analyzer, in accordance with some example embodiments. The method 900 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 900 are performed by the impact analyzer system 300 of FIG. 3, or any combination of one or more of its modules 310, 320, and 330, as described above.

At operation 910, the impact analyzer system 300 determines that a change to a rule has occurred. In some example embodiments, the impact analyzer system 300 detects that a rule that is stored in a database, such as in the database(s) 340, has been changed. The impact analyzer system 300 may determine that the rule change has occurred by periodically accessing the database to make the determination (e.g., checking to see if a rule has been flagged in the database as having been recently changed) or may receive an indication of the rule change from another computer component (e.g., rule change notifications may be pushed or pulled to the impact analyzer system 300 from a system that notifies organizations of rule changes). The impact analyzer system 300 may also determine that the rule change has occurred via a user manually entering details of the rule change directly into the impact analyzer system 300, where the entered details of the rule change may be stored in the database(s) 340. Other ways of determining that a change to a rule has occurred are also within the scope of the present disclosure.

At operation 920, the impact analyzer system 300 identifies a subset of people who are potentially affected by the change to the rule. The subset of people is identified from a group of people larger in quantity than the subset of people. For example, if a change is made to a rule that only affects salaried employees, as opposed to employees that are compensated based on hourly wages, then the impact analyzer system 300 may identify all of the salaried employees in the organization as being potentially affected by the rule change. In some example embodiments, the impact analyzer system 300 accesses corresponding records of people in an organization (e.g., employee records) stored in the database(s) 340, and analyzes the accessed records to identify which people in the organization satisfy one or more criteria for determining who is potentially affected by the rule change. In the example above, the accessed records may be used by the impact analyzer system 300 to determine which employees are salaried employees.

In some example embodiments, the impact analyzer system 300 makes an initial determination as to which people are potentially affected by the change to the rule, and then subsequently refines that determination to make a determination as to which people have been verified to be affected by the change to the rule. For example, the impact analyzer system 300 may be configured to query people for information, and then receive the information from the people, as will be discussed with respect to operations 950 and 960 below. The impact analyzer system 300 may use the information received from the people, such as information received via reply electronic messages, to determine which of the people who have been identified as being potentially affected by the rule change have been verified as being affected by the rule change. For example, in addition to only affecting salaried employees, a rule change may also only affect employees having 3 or more children. Therefore, the impact analyzer system 300 may first identify all of the salaried employees as being potentially affected by the rule change, then transmit electronic messages to those identified salaried employees prompting them to reply with the number of children they each have, and finally use their replies to verify which of the salaried employees have 3 or more children and will, therefore, be affected by the rule change. Other use cases are also within the scope of the present disclosure.

At operation 930, the impact analyzer system 300 causes a notification to be displayed on a computing device of a user. In some example embodiments, the notification indicates that the change to the rule potentially affects the subset of people. The notification may comprise information identifying how many people are affected by the rule change, different groupings to which the affected people belong (e.g., the specific department within the organization to which each person belongs), and a corresponding identity of each person affected by the rule change. In some example embodiments, the notification comprises a recommendation to contact the identified subset of people, such as to inform the identified subset of people of the rule change or to prompt the identified subset of people to provide data to be used in a subsequent analysis of the impact of the rule change.

At operation 940, the impact analyzer system 300, for each person in the identified subset of people, generates a corresponding electronic message that corresponds to the notification. In some example embodiments, the electronic message comprises a prompting to reply to the electronic message, as previously discussed above, such as in the example shown in FIG. 6. The notification may comprise a selectable user interface element configured to, based on its selection by the user, cause a message creation element to be displayed on the computing device of the user. The message creation element may be configured to receive user-entered text to include in an electronic message, such as via a body field. In some example embodiments, the message creation element comprises an address field that is auto-populated with an electronic destination of at least one person in the identified subset of people. The address field may be auto-populated with the entire identified subset of people. In some example embodiments, the body field of the message creation element is auto-populated with a prompting to reply to the electronic message.

At operation 950, the impact analyzer system 300, for each person in the identified subset of people, transmits the corresponding electronic message to a corresponding electronic destination associated with the person. The corresponding electronic destination may comprise an e-mail address (e.g., for receiving an e-mail) or a phone number (e.g., for receiving a text message). In some example embodiments, the notification that is displayed at operation 930 comprises a selectable user interface element configured to automatically transmit a corresponding electronic message to each person in the identified subset of people via a corresponding electronic destination of the person in response to selection of the selectable user interface element by the user, thereby reducing the number of steps that need to be performed by the user in sending the electronic message to each person in the identified subset of people, since the user would only need to select a single selectable user interface element provided in the notification in order to trigger a mass transmission to every person in the identified subset of people.

At operation 960, the impact analyzer system 300 tracks which people in the identified subset of people have replied to the electronic message and which people in the identified subset of people have not replied to the electronic message. For example, the impact analyzer system 300 may monitor an electronic destination (e.g., an e-mail account database) to which replies from the identified subset of people are expected to be transmitted and stored. In some example embodiments, the impact analyzer system 300 stores data provided by the people via their electronic replies in the database(s) 340 for subsequent use, such as to verify which people in the identified subset of people are affected by the rule change and how those people are affected, as previously discussed above.

At operation 970, the impact analyzer system 300 causes an indication of which people in the identified subset of people have replied to the electronic message and which people in the identified subset of people have not replied to the electronic message based on the tracking. In some example embodiments, the indication comprises a count of the number of people who have replied and a count of the number of people who have not replied, and the user may select a user interface element corresponding to either of the counts to trigger a further display of the identities of the corresponding people who have replied or who have not replied, as previously discussed with respect to FIG. 5.

It is contemplated that any of the other features described within the present disclosure can be incorporated into the method 900.

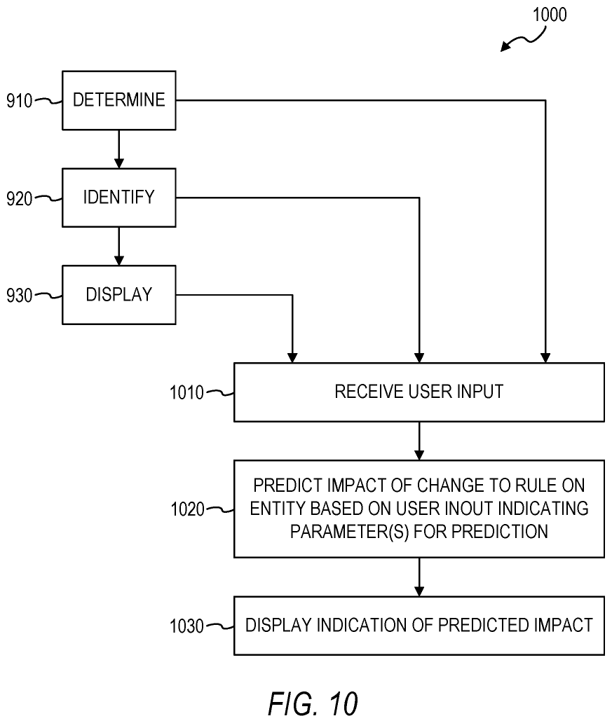

FIG. 10 is a flowchart illustrating a method 1000 of implementing a rule change impact analyzer, in accordance with some example embodiments. The method 1000 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 1000 are performed by the impact analyzer system 300 of FIG. 3, or any combination of one or more of its modules 310, 320, and 330, as described above. In some example embodiments, the method 1000 comprises operations 1010, 1020, and 1030, which may be performed subsequent to the performance of any one of operations 910, 920, and 930 of the method 900 in FIG. 9. For example, operation 1010 may be performed after the performance of operation 910, after the performance of operation 920, or after the performance of operation 930.

At operation 1010, the impact analyzer system 300 receives user input from the computing device of the user. For example, the impact analyzer system 300 may receive user input via the user interface 700 in FIG. 7 or via the user interface 800 in FIG. 8. In some example embodiments, the user input comprises one or more groupings of people within an organization (e.g., an identification of a particular department within the organization) or a time data indicating a timeframe for a prediction of an impact of a change to a rule. Other types of user input are also within the scope of the present disclosure.

At operation 1020, the impact analyzer system 300 predicts an impact of the change to the rule on an entity with which the identified subset of people are associated based on the user input. In some example embodiments, the user input indicates and is used as at least one parameter for the prediction of the impact. The impact analyzer system 300 may predict the impact of the change to the rule by performing one or more calculations for one or more metrics (e.g., financial cost) related to the rule. In some example embodiments, the models, algorithms, or formulas used for the calculations of the metrics are stored in the database(s) 340, where they are accessed by the impact analyzer system 300 to calculate the metrics for the predicted impact. The impact analyzer system 300 may also access other data stored in the database(s) 340 for the use in the calculations, such as employee records and the information received via the replies of the identified subset of people, such as the replies that are tracked at operation 960 in FIG. 9.

At operation 1030, the impact analyzer system 300 causes an indication of the predicted impact of the change to the rule to be displayed on the computing device of the user. For example, the indication of the predicted impact of the change to the rule may be displayed via the user interface 700 in FIG. 7. In some example embodiments, the indication of the predicted impact comprises a predicted financial impact of the rule change, such as shown in FIG. 7. However, other indications of the predicted impact are also within the scope of the present disclosure.

It is contemplated that any of the other features described within the present disclosure can be incorporated into the method 1000.

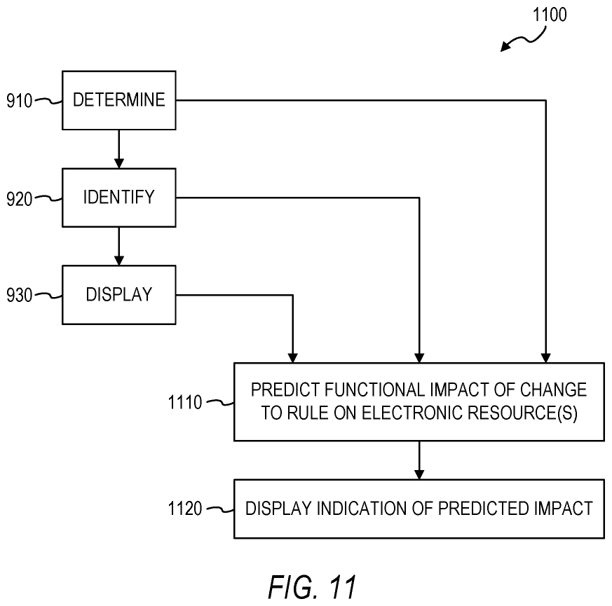

FIG. 11 is a flowchart illustrating a method 1100 of implementing a rule change impact analyzer, in accordance with some example embodiments. The method 1100 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 1100 are performed by the impact analyzer system 300 of FIG. 3, or any combination of one or more of its modules 310, 320, and 330, as described above. In some example embodiments, the method 1100 comprises operations 1110 and 1120, which may be performed subsequent to the performance of any one of operations 910, 920, and 930 of the method 900 in FIG. 9. For example, operation 1110 may be performed after the performance of operation 910, after the performance of operation 920, or after the performance of operation 930.

At operation 1110, the impact analyzer system 300 predicts a functional impact on one or more electronic resources due to the change to the rule. In some example embodiments, the predicted functional impact comprises a change in an amount of file size or memory requirements associated with complying with the rule or an increase in runtime associated with performing one or more computer operations associated with complying with the rule. However, other types of functional impacts may be predicted as well.

At operation 1120, the impact analyzer system 300 causes an indication of the predicted functional impact on the one or more electronic resources to be displayed on the computing device of the user. For example, the impact analyzer system 300 may cause an indication of the predicted functional impact to be displayed via the user interface 800 shown in FIG. 8.

It is contemplated that any of the other features described within the present disclosure can be incorporated into the method 1100.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

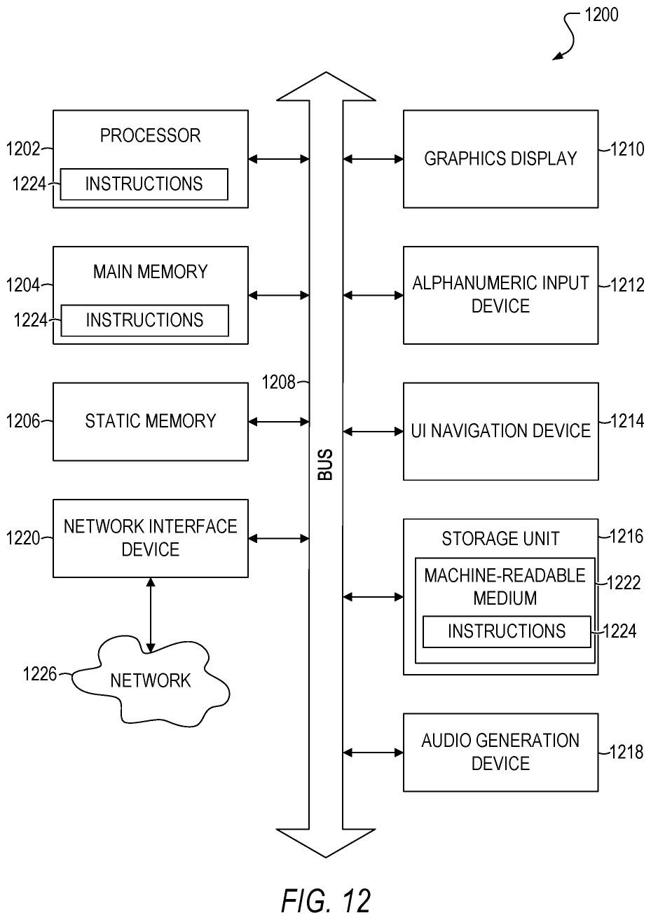

FIG. 12 is a block diagram of a machine in the example form of a computer system 1200 within which instructions 1224 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204, and a static memory 1206, which communicate with each other via a bus 1208. The computer system 1200 may further include a graphics or video display unit 1210 (e.g., a liquid crystal display (LCD) or a cathode ray tube (CRT)). The computer system 1200 also includes an alphanumeric input device 1212 (e.g., a keyboard), a user interface (UI) navigation (or cursor control) device 1214 (e.g., a mouse), a storage unit (e.g., a disk drive unit) 1216, an audio or signal generation device 1218 (e.g., a speaker), and a network interface device 1220.

The storage unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media. The instructions 1224 may also reside, completely or at least partially, within the static memory 1206.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Each of the features and teachings disclosed herein can be utilized separately or in conjunction with other features and teachings to provide a system and method for blind spot implementation in neural networks. Representative examples utilizing many of these additional features and teachings, both separately and in combination, are described in further detail with reference to the attached figures. This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The example methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the method steps disclosed herein. The structure for a variety of these systems will appear from the description herein. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to aid in understanding how the present teachings are practiced, but not intended to limit the dimensions and the shapes shown in the examples.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The following paragraphs provide example embodiments.

Example 1 includes a computer-implemented method comprising: determining, by at least one hardware processor, that a change to a rule stored in a database has occurred; predicting, by the at least one hardware processor, a functional impact on one or more electronic resources due to the change to the rule; and causing, by the at least one hardware processor, an indication of the predicted functional impact on the one or more electronic resources to be displayed on the computing device of the user.

Example 2 includes the computer-implemented method of example 1, wherein the predicted functional impact comprises an increase in runtime associated with performing one or more computer operations associated with complying with the rule.

Example 3 includes the computer-implemented method of example 1 or example 2, further comprising: identifying, by the at least one hardware processor, a subset of people who are potentially affected by the change to the rule, the subset of people being identified from a group of people larger in quantity than the subset of people, wherein the functional impact on the one or more electronic resources is predicted based on the identified subset of people.

Example 4 includes the computer-implemented method of any one of examples 1 to 3, further comprising: identifying, by the at least one hardware processor, a subset of people who are potentially affected by the change to the rule, the subset of people being identified from a group of people larger in quantity than the subset of people; and causing, by the at least one hardware processor, a notification to be displayed on a computing device of a user, the notification indicating that the change to the rule potentially affects the subset of people.

Example 5 includes the computer-implemented method of any one of examples 1 to 4, wherein the notification comprises a recommendation to contact the identified subset of people.

Example 6 includes the computer-implemented method of any one of examples 1 to 5, further comprising: for each person in the identified subset of people, generating, by the at least one hardware processor, a corresponding electronic message that corresponds to the notification, the electronic message comprising a prompting to reply to the electronic message; and for each person in the identified subset of people, transmitting, by the at least one hardware processor, the corresponding electronic message to a corresponding electronic destination associated with the person.

Example 7 includes the computer-implemented method of any one of examples 1 to 6, wherein the corresponding electronic destination comprises an e-mail address or a phone number.

Example 8 includes the computer-implemented method of any one of examples 1 to 7, further comprising: tracking, by the at least one hardware processor, which people in the identified subset of people have replied to the electronic message and which people in the identified subset of people have not replied to the electronic message; and causing, by the at least one hardware processor, an indication of which people in the identified subset of people have replied to the electronic message and which people in the identified subset of people have not replied to the electronic message based on the tracking.

Example 9 includes the computer-implemented method of any one of examples 1 to 8, wherein the notification comprises a selectable user interface element configured to automatically transmit a corresponding electronic message to each person in the identified subset of people via a corresponding electronic destination of the person in response to selection of the selectable user interface element by the user.

Example 10 includes the computer-implemented method of any one of examples 1 to 9, wherein the electronic message comprises a prompting to reply to the electronic message.

Example 11 includes the computer-implemented method of any one of examples 1 to 10, wherein the notification comprises a selectable user interface element configured to, based on its selection by the user, cause a message creation element to be displayed on the computing device of the user, the message creation element configured to receive user-entered text to include in an electronic message and comprises an address field that is auto-populated with an electronic destination of at least one person in the identified subset of people.

Example 12 includes the computer-implemented method of any one of examples 1 to 11, wherein the message creation element also comprises a body field that is auto-populated with a prompting to reply to the electronic message.

Example 13 includes the computer-implemented method of any one of examples 1 to 12, further comprising: receiving, by the at least one hardware processor, user input from the computing device of the user; predicting, by the at least one hardware processor, another impact of the change to the rule on an entity with which the identified subset of people are associated based on the user input, the user input indicating at least one parameter for the prediction of the impact; and causing, by the at least one hardware processor, an indication of the predicted impact of the change to the rule to be displayed on the computing device of the user.

Example 14 includes a computer-implemented method comprising: determining, by at least one hardware processor, that a change to a rule stored in a database has occurred; identifying, by the at least one hardware processor, a subset of people who are potentially affected by the change to the rule, the subset of people being identified from a group of people larger in quantity than the subset of people; and causing, by the at least one hardware processor, a notification to be displayed on a computing device of a user, the notification indicating that the change to the rule potentially affects the subset of people.

Example 15 includes the computer-implemented method of example 14, wherein the notification comprises a recommendation to contact the identified subset of people.

Example 16 includes the computer-implemented method of example 14 or example 15, further comprising: for each person in the identified subset of people, generating, by the at least one hardware processor, a corresponding electronic message that corresponds to the notification, the electronic message comprising a prompting to reply to the electronic message; and for each person in the identified subset of people, transmitting, by the at least one hardware processor, the corresponding electronic message to a corresponding electronic destination associated with the person.

Example 17 includes the computer-implemented method of any one of examples 14 to 16, wherein the corresponding electronic destination comprises an e-mail address or a phone number.

Example 18 includes the computer-implemented method of any one of examples 14 to 17, further comprising: tracking, by the at least one hardware processor, which people in the identified subset of people have replied to the electronic message and which people in the identified subset of people have not replied to the electronic message; and causing, by the at least one hardware processor, an indication of which people in the identified subset of people have replied to the electronic message and which people in the identified subset of people have not replied to the electronic message based on the tracking.

Example 19 includes the computer-implemented method of any one of examples 14 to 18, wherein the notification comprises a selectable user interface element configured to automatically transmit a corresponding electronic message to each person in the identified subset of people via a corresponding electronic destination of the person in response to selection of the selectable user interface element by the user.

Example 20 includes the computer-implemented method of any one of examples 14 to 19, wherein the electronic message comprises a prompting to reply to the electronic message.

Example 21 includes the computer-implemented method of any one of examples 14 to 20, wherein the notification comprises a selectable user interface element configured to, based on its selection by the user, cause a message creation element to be displayed on the computing device of the user, the message creation element being configured to receive user-entered text to include in an electronic message and comprises an address field that is auto-populated with an electronic destination of at least one person in the identified subset of people.

Example 22 includes the computer-implemented method of any one of examples 14 to 21, wherein the message creation element also comprises a body field that is auto-populated with a prompting to reply to the electronic message.

Example 23 includes the computer-implemented method of any one of examples 14 to 22, further comprising: receiving, by the at least one hardware processor, user input from the computing device of the user; predicting, by the at least one hardware processor, an impact of the change to the rule on an entity with which the identified subset of people are associated based on the user input, the user input indicating at least one parameter for the prediction of the impact; and causing, by the at least one hardware processor, an indication of the predicted impact of the change to the rule to be displayed on the computing device of the user.

Example 24 includes the computer-implemented method of any one of examples 14 to 23, further comprising: predicting, by the at least one hardware processor, a functional impact on one or more electronic resources due to the change to the rule; and causing, by the at least one hardware processor, an indication of the predicted functional impact on the one or more electronic resources to be displayed on the computing device of the user.

Example 25 includes the computer-implemented method of any one of examples 14 to 24, wherein the predicted functional impact comprises an increase in runtime associated with performing one or more computer operations associated with complying with the rule.

Example 26 includes a system comprising: at least one processor; and a non-transitory computer-readable medium storing executable instructions that, when executed, cause the at least one processor to perform the method of any one of examples 1 to 25.

Example 27 includes a non-transitory machine-readable storage medium, tangibly embodying a set of instructions that, when executed by at least one processor, causes the at least one processor to perform the method of any one of examples 1 to 25.

Example 28 includes a machine-readable medium carrying a set of instructions that, when executed by at least one processor, causes the at least one processor to carry out the method of any one of examples 1 to 25.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
determining, by at least one hardware processor, that a change to a rule stored in a database has occurred;
predicting, by the at least one hardware processor, a functional impact on one or more electronic resources due to the change to the rule; and
causing, by the at least one hardware processor, an indication of the predicted functional impact on the one or more electronic resources to be displayed on a computing device of a user.

2. The computer-implemented method of claim 1, wherein the predicted functional impact comprises an increase in runtime associated with performing one or more computer operations associated with complying with the rule.

3. The computer-implemented method of claim 1, further comprising:
identifying, by the at least one hardware processor, a subset of people who are potentially affected by the change to the rule, the subset of people being identified from a group of people larger in quantity than the subset of people,
wherein the functional impact on the one or more electronic resources is predicted based on the identified subset of people.

4. The computer-implemented method of claim 1, further comprising:
identifying, by the at least one hardware processor, a subset of people who are potentially affected by the change to the rule, the subset of people being identified from a group of people larger in quantity than the subset of people; and
causing, by the at least one hardware processor, a notification to be displayed on the computing device of the user, the notification indicating that the change to the rule potentially affects the subset of people.

5. The computer-implemented method of claim 4, wherein the notification comprises a recommendation to contact the identified subset of people.

6. The computer-implemented method of claim 4, further comprising:
for each person in the identified subset of people, generating, by the at least one hardware processor, a corresponding electronic message that corresponds to the notification, the electronic message comprising a prompting to reply to the electronic message; and
for each person in the identified subset of people, transmitting, by the at least one hardware processor, the corresponding electronic message to a corresponding electronic destination associated with the person.

7. The computer-implemented method of claim 6, wherein the corresponding electronic destination comprises an e-mail address or a phone number.

8. The computer-implemented method of claim 6, further comprising:
tracking, by the at least one hardware processor, which people in the identified subset of people have replied to the electronic message and which people in the identified subset of people have not replied to the electronic message; and
causing, by the at least one hardware processor, an indication of which people in the identified subset of people have replied to the electronic message and which people in the identified subset of people have not replied to the electronic message based on the tracking.

9. The computer-implemented method of claim 4, wherein the notification comprises a selectable user interface element configured to automatically transmit a corresponding electronic message to each person in the identified subset of people via a corresponding electronic destination of the person in response to selection of the selectable user interface element by the user.

10. The computer-implemented method of claim 9, wherein the electronic message comprises a prompting to reply to the electronic message.

11. The computer-implemented method of claim 4, wherein the notification comprises a selectable user interface element configured to, based on its selection by the user, cause a message creation element to be displayed on the computing device of the user, the message creation element being configured to receive user-entered text to include in an electronic message and comprises an address field that is auto-populated with an electronic destination of at least one person in the identified subset of people.

12. The computer-implemented method of claim 11, wherein the message creation element also comprises a body field that is auto-populated with a prompting to reply to the electronic message.

13. The computer-implemented method of claim 4, further comprising:
receiving, by the at least one hardware processor, user input from the computing device of the user;
predicting, by the at least one hardware processor, another impact of the change to the rule on an entity with which the identified subset of people are associated based on the user input, the user input indicating at least one parameter for the prediction of the impact; and
causing, by the at least one hardware processor, an indication of the predicted impact of the change to the rule to be displayed on the computing device of the user.

14. A system comprising:
at least one hardware processor; and
a non-transitory computer-readable medium storing executable instructions that, when executed, cause the at least one hardware processor to perform operations comprising:
determining that a change to a rule stored in a database has occurred;
predicting a functional impact on one or more electronic resources due to the change to the rule; and
causing an indication of the predicted functional impact on the one or more electronic resources to be displayed on a computing device of a user.

15. The system of claim 14, wherein the predicted functional impact comprises an increase in runtime associated with performing one or more computer operations associated with complying with the rule.

16. The system of claim 14, wherein the operations further comprise:
identifying a subset of people who are potentially affected by the change to the rule, the subset of people being identified from a group of people larger in quantity than the subset of people,
wherein the functional impact on the one or more electronic resources is predicted based on the identified subset of people.

17. The system of claim 14, wherein the operations further comprise:
identifying a subset of people who are potentially affected by the change to the rule, the subset of people being identified from a group of people larger in quantity than the subset of people; and
causing a notification to be displayed on the computing device of the user, the notification indicating that the change to the rule potentially affects the subset of people.

18. The system of claim 17, wherein the notification comprises a recommendation to contact the identified subset of people.

19. The system of claim 17, wherein the operations further comprise:
for each person in the identified subset of people, generating a corresponding electronic message that corresponds to the notification, the electronic message comprising a prompting to reply to the electronic message; and
for each person in the identified subset of people, transmitting the corresponding electronic message to a corresponding electronic destination associated with the person.

20. A non-transitory machine-readable storage medium, tangibly embodying a set of instructions that, when executed by at least one hardware processor, causes the at least one processor to perform operations comprising:
determining that a change to a rule stored in a database has occurred;
predicting a functional impact on one or more electronic resources due to the change to the rule; and
causing an indication of the predicted functional impact on the one or more electronic resources to be displayed on a computing device of a user.
